(19) United States
(12) Patent Application Publication
(10) Pub. No.: US 2004/0002938 A1
(43) Pub. Date: Jan. 1, 2004

(54) Device and method for exchanging information

(75) Inventor: Yuichiro Deguchi, San Mateo, CA (US)

Correspondence Address: RICHARD T. FUJII, VALLEY OAK LAW, 5655 SILVER CREEK VALLEY ROAD, #106, SAN JOSE, CA, 95138, US

(73) Assignee: Sony Corporation and Sony Electronics Inc.

(21) Appl. No.: 10/184,576

(22) Filed: Jun. 28, 2002

(51) Int. Cl. G06F 7/00

(52) U.S. Cl. 707/1

(57) ABSTRACT

Method and system for sharing information related to bookmarked music clips between users of electronic music marker devices which includes a communications port for direct exchange of unique identification corresponding to each marker device, and optionally establishing third party user access permission level with a corresponding access level flag transmitted with each exchange of device identification with other music marker devices to allow convenient and easy exchange of information related to bookmarked music clips and playlists is provided.

### BACKGROUND OF THE INVENTION

1. Field of the Invention

The present invention relates to electronic music markers. More particularly, the present relates to electronic markers which are capable of interfacing with other electronic markers to exchange information related to marked information by exchanging or transferring marker identification code to third party marker users for accessing marked information through the e-marker.com account.

2. Description of the Related Art

With increase in portable electronic devices such as personal digital assistants (PDAs) and WAP (Wireless Application Protocol) enabled mobile telephone and so on, there has been a steady increase in these devices capable of performing more operations.

Sony Corporation and its U.S. subsidiary, Sony Electronics, Inc., introduced a so called e-marker which is capable of “bookmarking” a music clip while being played on a radio and is capable of recalling the information related to the bookmarked music clip such as the name of the song, the artist, the album containing the song and so on. Using the e-marker, a user can conveniently access the music clip information that the user listened to on the radio at a later time without the need to memorize the information or wait hopefully for the disc jockey on the radio to provide that information. In this manner, if the user wants to, for example, purchase the music album which the user has marked using the e-marker, the user can easily identify the necessary information related to the marked music clip from the e-marks provided by the e-marker.

Further information relating to the operation of the e-marker can be found in pending application Ser. No. 09/126,007 filed on Jul. 29, 1998 and application Ser. No. 09/401,103 filed on Sep. 22, 1999, both assigned to Sony Corporation, joint assignee of the present application with Sony Electronics, Inc., a subsidiary of Sony Corporation, the disclosures of each of which are herein incorporated in their entirely by reference for all purposes.

While e-marker provides the ability to bookmark broadcast music clips for accessing information related to the bookmarked music clips at a later point in time, for example, by accessing the user's e-marker.com account, it is configured to only provide information related to bookmarked music clips that the account holder has bookmarked. As the market for emarker device grows, and likewise, the user's emarker.com account, it would be desirable to be able to exchange bookmarked music clip information by allowing access to each other's playlists of bookmarked music clips, for example.

### SUMMARY OF THE INVENTION

In view of the foregoing, a system for exchanging information between data marker devices of one embodiment includes a first data marker having a first marker identification, and a second data marker configured to transmit a request for a marker identification to the first data marker, and in response thereto, receiving the first marker identification.

A method of another embodiment includes receiving a device identification information, transmitting the received device identification information, and receiving information corresponding to a device having the device identification.

A method of yet another embodiment includes detecting a communication from a user terminal, receiving a device identification information, retrieving a playlist information corresponding to the device identification information, and transmitting the playlist to the user terminal.

A method of still a further embodiment includes detecting a transmission of a third party device identification information, receiving the third party device identification and an access level flag, storing the received third party device identification and the access level flag.

A system for exchanging information between data marker devices of still a further embodiment includes first marking means having a first identification, and second marking for transmitting a request for an identification to the first marking means, and in response thereto, receiving the first identification.

These and other features and advantages of the present invention will be understood upon consideration of the following detailed description of the invention and the accompanying drawings.

### BRIEF DESCRIPTION OF THE DRAWINGS

FIG. 1 illustrates an overall e-marker information exchange system in accordance with one embodiment;

FIG. 2 illustrates a block diagram of the electronic bookmarking device shown in FIG. 1;

FIG. 3 illustrates an electronic music marker device and cradle-type docking connection;

FIG. 4 is one embodiment of a database illustration of the bookmarks in a storage unit of the electronic music marker device;

FIG. 5 is one embodiment of a database illustration of marker device ID exchange information in a storage unit of the electronic a music marker device;

FIG. 6 is a flowchart for illustrating one embodiment of the electronic music marker device operation;

FIG. 7 is a flowchart for illustrating one embodiment of downloading data from the user's e-marker account to the music marker device;

FIG. 8 illustrates one embodiment of a user terminal of the e-marker information exchange system shown in FIG. 1;

FIG. 9 illustrates one embodiment of the server terminal of the e-marker information exchange system shown in FIG. 1;

FIG. 10 illustrates one embodiment of a user account database of the server terminal storage unit shown in FIG. 9;

FIG. 11 illustrates one embodiment of a playlist database of the server terminal data storage unit shown in FIG. 9;

FIG. 12 illustrates one embodiment of a user playlist database of the server terminal data storage unit shown in FIG. 9;

FIGS. 13A-13B are flowcharts for illustrating one embodiment of electronic music marker device ID exchange procedure; and

FIGS. 14A-14B are flowcharts for illustrating one embodiment of retrieving and transmitting playlist of other music marker devices after ID exchange procedure.

### DETAILED DESCRIPTION

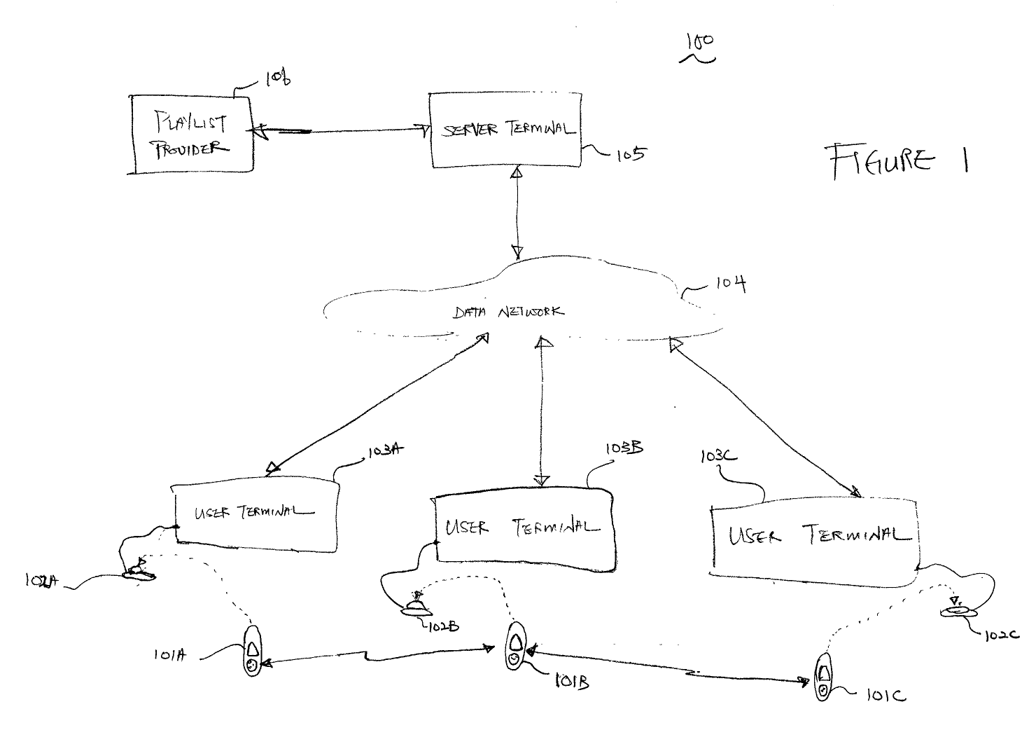

FIG. 1 illustrates an overall e-marker information exchange system in accordance with one embodiment. Referring to FIG. 1, e-marker information exchange system 100 includes a plurality of user terminals 103A-103C each connected to data network 104 such as the internet via connection protocols such as TCP/IP, Appletalk, using connection interface unit (not shown) such as a dial-up modem through an internet service provider (ISP), a broadband network such as a DSL or cable modem, a T1 or LAN connection, or any other means for connecting to the internet. Each user terminal 103A-103C is configured to connect to a respective electronic music marker device 101A-101C via a cradle type connection unit 102A-102C, and configured to receive, upon synchronization operation with the respective music marker devices 101A-101C, bookmark information stored in music marker devices 101A-101C. In one embodiment, the bookmark information transmitted from music marker devices 101A-101C to the respective user terminals 103A-103C may include corresponding music marker device 101A-101C unique device identification code, the number of stored bookmarks, and corresponding date and time stamp for each stored bookmarks, as well as device ID exchange information including IDs of other marker devices and optionally, the corresponding access level flags.

Also shown in FIG. 1 is server terminal 105 connected to data network 104 for communicating with user terminals 103A-103C for data transfer. Moreover, as further shown in FIG. 1, server terminal 105 is coupled to playlist provider 106. Playlist provider 106 is configured to transmit playlist information corresponding to registered radio station broadcasts such as the title, artist and album information for the music broadcast from the registered radio station. In one aspect, playlist provider may be configured to periodically transmit information related to the music broadcast from the registered radio stations over a predetermined period of time. For example, depending upon factors such as the target market for the registered radio station or the geographic location of the registered radio station, playlist provider 106 may be configured to transmit broadcast music clip information to server terminal 105 within ten minutes from the termination of the respective music broadcast, or alternatively, within 12 or 24 hours from a predetermined broadcast cutoff time such as 10 PM or midnight. Moreover, while playlist provider 106 is shown as communicating with server terminal 105 via a dedicated connection, within the scope of the present invention, server terminal 105 and playlist provider 106 may communicate via a connection through data network 104 for data transfer.

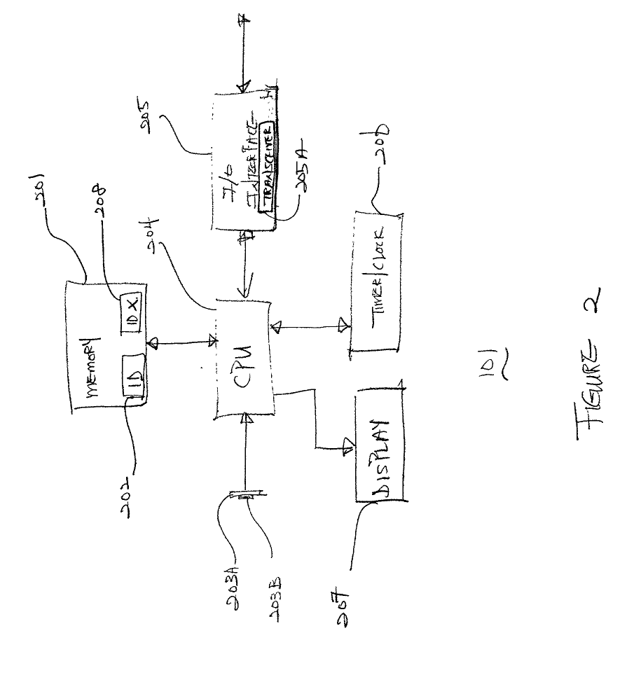

FIG. 2 illustrates a block diagram of the electronic music marker device shown in FIG. 1. Referring to FIG. 2, music marker device 101 includes memory 201 such as a Random Access Memory (RAM) and a Read-Only Memory (ROM), and stored thereon is a unique bookmarking device identification code 202 which can include a predetermined combination of letters or numbers, or a combination of both. In one embodiment, identification code 202 can include a thirteen-digit number which is unique to each bookmarking device and is pre-stored in the ROM portion of memory 201. It should be noted that the description of music marker device 101 set forth herein applies equally to each device 101A-101C shown in FIG. 1.

Referring to FIG. 2, also included in memory 320 is ID exchange database 208. As will be discussed in further detail below, ID exchange database 208 in one embodiment is configured to store music marker device IDs of other device holders who have transmitted their unique IDs along with an access level flag. Using the unique IDs of other music marker device holders, it is possible to retrieve playlists of music clips bookmarked by the other device holders. Access level flag in one embodiment is provided to establish the permitted level of access by other device holders to retrieve playlists of bookmarked music clips.

Further shown in FIG. 2 is controller (CPU) 204 which is configured to control the various components of bookmarking device 101 as shown such as display unit 207, input units 203A, 203B such as bookmarking buttons for bookmarking broadcast music clips over a registered radio or television station, or for bookmarking locations, input/output (I/O) interface 205, clock/timer 206, and memory 201. As can be seen from FIG. 2, upon receiving an input signal from a user of music marker device 101 via input units 203A, 203B, controller 204 may be configured to access the various components of device 101 depending upon the input command received from the user, to perform one or a plurality of processings, executing the input command of the user.

Moreover, I/O interface 205 of music marker device 101 shown in FIG. 2 may be configured to, under the control of controller 204, interface with server terminal 105. Additionally, I/O interface 205 is provided with transceiver 205A which may be used to communicate directly with other marker devices to exchange data. Display unit 207 in accordance with one embodiment of the present invention may include a liquid crystal display (LCD), a plasma-type display, and the like, configured to display text or image data, or a combined text and image data. Furthermore, as discussed above, the input unit 203A, 203B may include spring-loaded type input buttons for operation by the user's finger. Alternatively, input unit 203A, 203B may include a touchpad-type screen integrated with display unit 207 for simultaneously inputting and displaying information, where the user can tap the pressure-sensitive screen using a stylus or the like to enter input commands. Timer/clock 206 of music marker device 101 in accordance with one aspect of the present invention may be configured to provide actual time information as well as generate an elapsed time information depending upon the input command from the user under the control of controller 204.

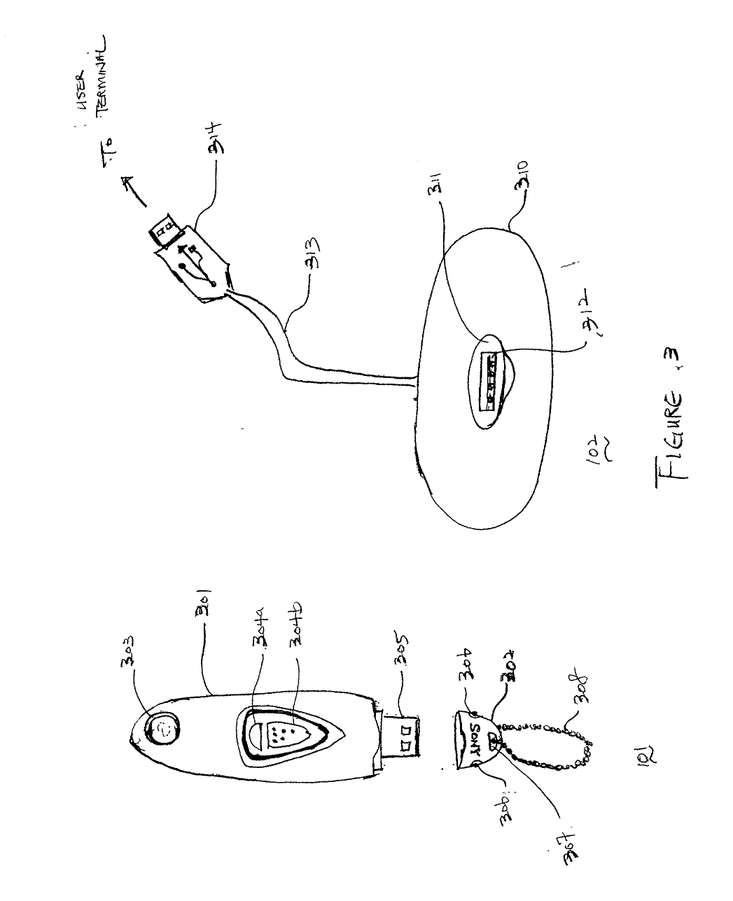

FIG. 3 illustrates an electronic music marker device and cradle-type docking connection of one embodiment. It should be noted that the description of music marker device 101 and the cradle-type docking connection set forth herein applies equally to each device 101A-101C and the respective cradle-type connections 102A-102C shown in FIG. 1. Referring to FIG. 3, music marker device 101 includes a housing comprising body 301 and cap 302. Body 301 is provided with e-mark button 303 which is configured for user input commands. Also provided on body 301 are display panels 304a and 304b which are configured to display the number of user inputted e-marks and the type of registered broadcast station for the corresponding e-marks, respectively. Finally, body 301 includes communication port 305 such as a USB port which is integrated onto body 301 such that, as will be discussed in further detail below, body 301 may be placed on top of cradle type connection 102 with communication port 305 capable of being plugged into the corresponding port on cradle 102.

Cap 302 can be attached to body 301 when access to communication port 305 is unnecessary. As shown, cap 302 is provided with a pair of release/lock buttons 306 on either side of cap 302 such that by depressing release/lock buttons 306 when cap 302 is locked with body 301, cap 302 can be released from a locked position and communication port 305 may be accessed. Furthermore, cap 302 is provided with hole 307 substantially at its edge position such that link chain 308 can be looped through hole 307 to allow the user to attach the music marker device 101 to a key chain or the like.

Referring back to FIG. 3, cradle-type connection 102 is provided with cradle base 310 substantially flat on its bottom surface (not shown) to rest cradle 102 on a flat surface such as a desktop and a book shelf. On the other side of the bottom surface of cradle 102 is receiving section 311 substantially positioned on the middle of cradle 102, where communication port 312 such as a USB port is provided for connection to communication port 305 of the music marker device 110. Also shown in FIG. 3 is cable 313 attached to cradle connection 102 with a communication port 314 at its other end. In this manner, cradle 102 may be connected to user terminal 103 accessing the user's e-marker account over an internet connection.

Additional detailed information relating to the operation of the electronic music marker device 110 may be found in pending application Ser. No. 09/126,007 filed on Jul. 29, 1998 and application Ser. No. 09/401,105 filed on Sep. 22, 1999, both assigned to Sony Corporation, joint-assignee of the present application with Sony Electronics, Inc., a subsidiary of Sony Corporation, the disclosures of each of which are herein incorporated in their entirely by reference for all purposes.

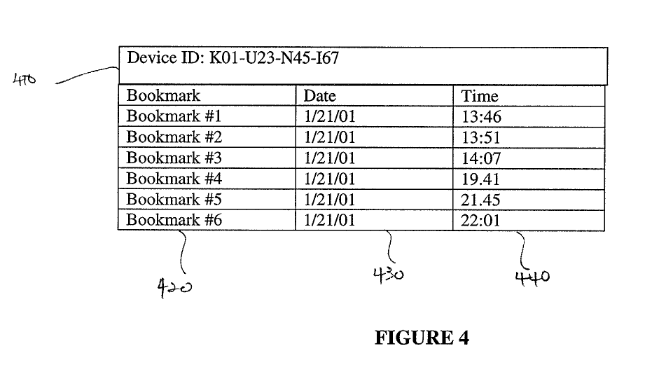

FIG. 4 is one embodiment of a database illustration of the bookmarks in a storage unit of the electronic music marker device. Referring to FIG. 4, storage unit such as a random access memory (RAM) and/or a read-only memory (ROM) may be configured to store device ID unique for each marker device 101 in device ID field 410. Additionally, storage unit of marker device 101 may also be configured to store bookmarks input by the user in bookmark field 420, with a corresponding date and time information (for example, a time stamp) for the respective bookmarks in date field 430 and time field 440, respectively. In this manner, when music marker device 101 is connected to server terminal 105 via user terminal 103, information stored in marker device storage unit such as the bookmarks and the corresponding date and time stamp information may be transmitted to server terminal 105.

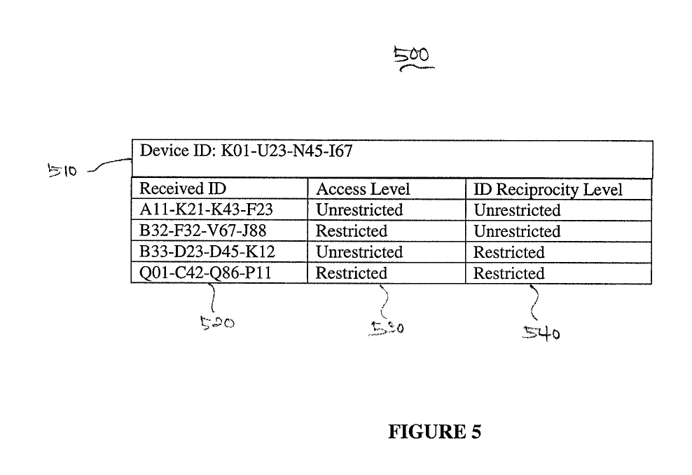

FIG. 5 is one embodiment of a database illustration of marker device ID exchange information in a storage unit of the electronic a music marker device. Referring to FIG. 5, ID exchange database 500 for device having ID “K01-U23-N45-I67” stored in device ID field 510 includes received ID field 520, access level field 530 and ID reciprocity level field 540.

In one embodiment, ID exchange database 500 is configured to store device IDs received from other music marker devices and/or the corresponding access level for each received ID. Furthermore, ID exchange database 500 may also include ID reciprocity level field 540 in the case where the marker device which received another marker device ID also transmitted its own device ID to the device whose device ID it received.

Referring back to FIG. 5, it can be seen that device with ID “K01-U23-N45-I67” has stored in its ID exchange database 500 device ID “A11-K21-K34-F23” in received ID field 520 with an “unrestricted” flag stored in the corresponding access level field 530 as well as an “unrestricted” flag stored in the corresponding ID reciprocity level field 540, and corresponding to device ID “B32-F32-V67-J88” stored in received ID field 520, a “restricted” flag and an “unrestricted” flag are respectively stored in the access level field 530 and ID reciprocity level field 540. Furthermore, as can be seen, device ID “B33-D23-D45-K12” stored in received ID field 520 of ID exchange database 500 has corresponding thereto an “unrestricted” flag and a “restricted” flag stored in access level field 530 and ID reciprocity level field 540, while device ID “Q01-C42-Q86-P11” stored in received ID field 520 has corresponding thereto “restricted” flags stored in both access level field 530 and ID reciprocity level field 540.

In this manner, it can be seen from ID exchange database 500 of music marker device with device ID “K01-U23-N45-I67” has received device IDs from four separate music marker devices having the corresponding device IDs stored in the respective rows in received ID field 520, and each device ID stored in received ID field 520 including a flag in access level field 530 indicating the access level granted by the respective music marker devices for accessing their respective bookmarked playlists and other information provided from their emarker.com account, and a flag in ID reciprocity level field 540.indicating the level of access granted to each marker device whose device ID and the corresponding access level flag has been received.

FIG. 6 is a flowchart for illustrating one embodiment of the electronic music marker device operation. Referring to FIG. 6, at step 610, electronic music marker device 101 detects user's input operation of e-mark buttons 203A, 203B. Then, at step 620, music marker device 101 illuminates or flashes a corresponding e-mark display panel 304a, 304b. As discussed above, in one embodiment, the corresponding e-mark display panel 304a, 304b may be configured to display time and/or date information of the user's input operation of e-mark buttons 203A, 203B.

At step 630, music marker device 101 determines whether all available e-mark display panels 304a, 304b are being used (for example, illuminated or flashing in response to user's input operation of e-mark button 203A, 203B). If it is determined that there are e-mark display panels 304a, 304b available, music marker device 101 waits for further input operation by the user at step 610. On the other hand, if it is determined at step 530 that all available e-mark display panels 304a, 304b are in use, then at step 640, electronic music marker device 101 generates an output signal to inform the user that music marker device 101 has reached its maximum number of e-marks that it can handle, and the procedure ends. In one embodiment, the output signal from music marker device 101 to inform the user that it has reached its maximum number of e-marks it can handle may be an audible output signal such as an audible tone via an audio output terminal (not shown). Alternatively, music marker device 101 may be configured to flash all e-mark display panels 203A. 203B simultaneously for a predetermined period of time to visually indicate to the user that it has reached its maximum number of e-marks that it can handle.

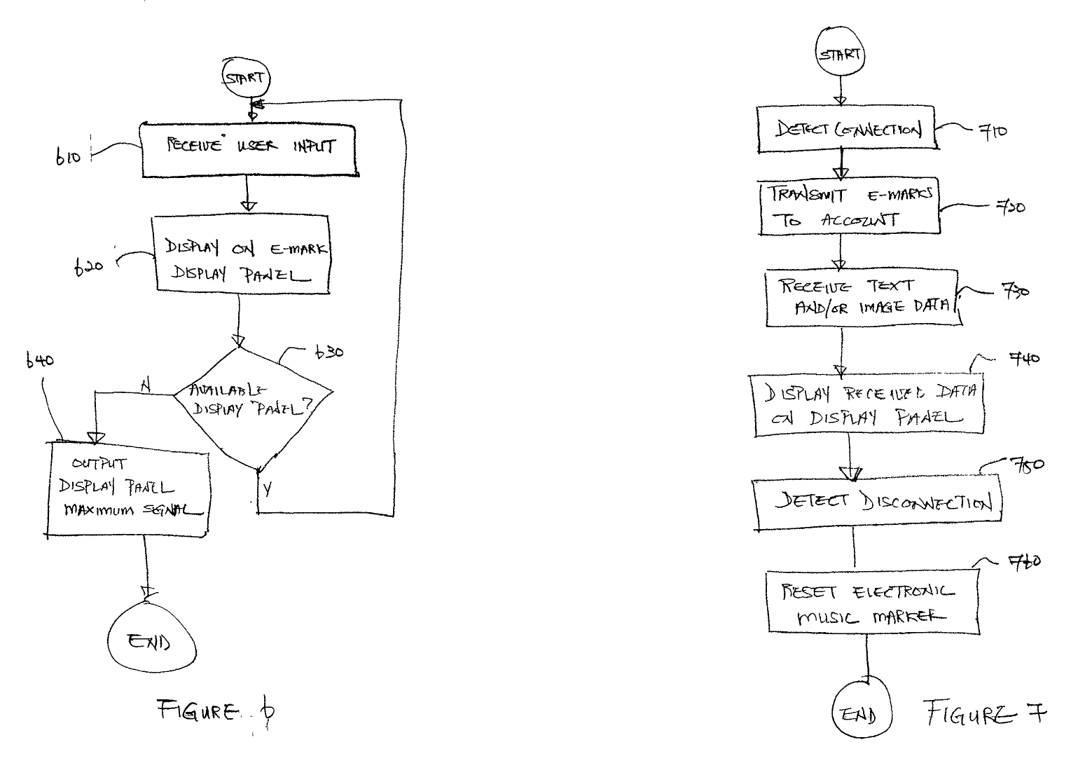

FIG. 7 is a flowchart for illustrating one embodiment of downloading data from the user's e-marker account to the music marker device. Referring to FIG. 7, at step 710, music marker device 101 detects a connection to user terminal 103 connected to the internet. After the user enters the user's account information and performing necessary e-marker account access steps at user terminal 103, at step 720, data corresponding to the e-marks (bookmarks) stored in music marker device 101 is transmitted to the user's e-marker account via gateway terminal 130, and in response, the corresponding text and/or image (including video) data are retrieved from server terminal 105 of e-marker.com web site and transmitted to the user's e-marker account. Then, at step 730, the text and/or image data corresponding to each e-marks are downloaded onto music marker device 101. At step 740, the downloaded text and/or image data are displayed on each corresponding e-mark display panel 304a, 304b on music marker device 101.

When the user disconnects music marker device 101 from user terminal 103, the termination of the is detected at step 750, and at step 760, music marker device 101 is reset such that previously stored e-marks inputted by the user may be erased from the storage unit of music marker device 101, and correspondingly, the illuminated e-mark display panels 304a, 304b are turned off. The user may then operate e-mark button 203A, 203B again to input additional bookmarks of music clip broadcasts from registered radio and television broadcast stations.

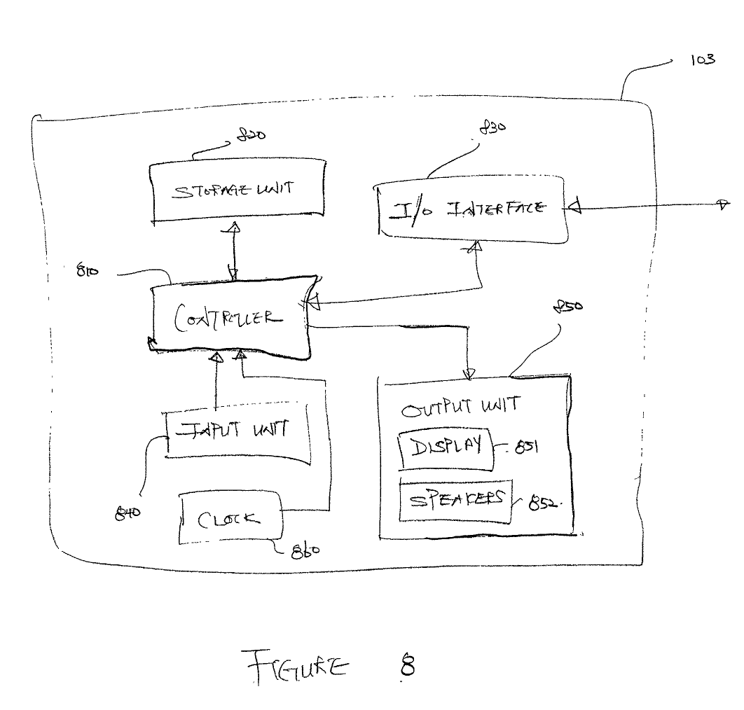

FIG. 8 illustrates one embodiment of a user terminal of the e-marker music find system. Referring to FIG. 8, user terminal 103 in one embodiment may include controller 810, storage unit 820, I/O interface unit 830, input unit 840, output unit 850 and clock 860. Storage unit 820 of user terminal 103 may include one or more of an internal or an external storage device such as a hard disc drive (HDD), a CD-RW drive, or a zip drive. Input unit 840 of user terminal 103 may include one of or a combination of a keyboard, a mouse, a touchpad input device and a voice-recognition type input terminal including a microphone with corresponding software installed in user terminal 103 for performing input operations by voice commands. Controller 810 is coupled to input unit 840 and accordingly, may be configured to process the input data received from input unit 840. Storage unit 820 is similarly coupled to controller 820, and may be configured to store inputted data received from input unit 840 or other data received by user terminal 103. Clock 860 also coupled to controller 810 may be configured to provide time information to controller 810 which, in turn, may be stored in storage unit 820 as discussed in further detail below.

Referring back to FIG. 8, I/O interface unit 830 in one embodiment may be coupled to controller 810, and may be configured to interface with other user terminals 103 in the network or to communicate with server terminal 105. In one embodiment, I/O interface circuit 830 of user terminal 103 may include a communication port configured to connect to the date network 104 such as the internet via connections such as, but not limited to, a modem dial-up through an internet service provider (ISP), a DSL or cable modem-type connection, and a T1, IDSN or LAN type connection. Communication port integrated in I/O interface circuit 830 may include, among others, one of a USB port, a serial port, a parallel port, an IEEE 1394 communication port, a IrDA communication port, and a Bluetooth enabled communication port.

Referring again to FIG. 8, output unit 850 of user terminal 103 may include display unit 851 and speakers 852. Display unit 851 may be configured to output text, image (for example, in .jpg or .gif formats) or video data (for example, in .avi or .mpeg formats) while speakers may be configured to output sound data in the form of, for example, .wav file format. In this manner, user terminal 103 in one embodiment may be configured to communicate with server terminal 105 over the internet connection 104.

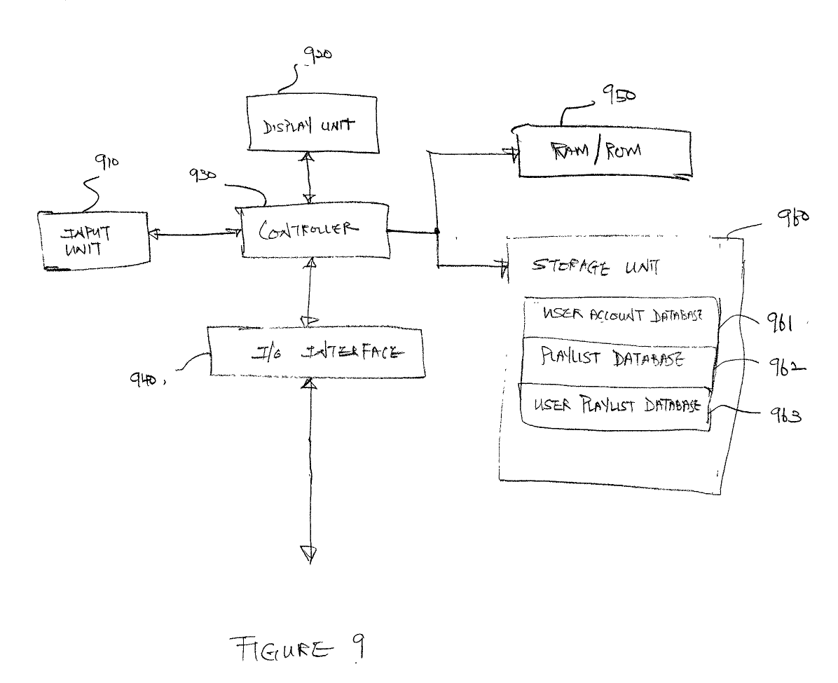

FIG. 9 illustrates one embodiment of a server terminal in the e-marker information exchange system. Referring to FIG. 9, server terminal 105 includes display unit 920, input unit 910, controller 930, input/output (I/O) interface unit 940, memory (RAM/ROM) 950, and storage unit 960. Display unit 920 may be configured to display various information including the status of server terminal 105 connection, data transfer processing status, data upload information, and any other information related to the operation of server terminal 105.

Input unit 910 of server terminal 105 may be configured to provide input means for operations such as server terminal maintenance, data backup, data query and so on. As can be seen, both display unit 111 and input unit 910 are coupled to controller 930. In one embodiment, controller 930 may be configured to control the display of information on display unit 920 in accordance with input operations received from input unit 910. Alternatively, server terminal 105 may exclude display unit 920.

Referring back to FIG. 9, controller 930 of server terminal 105 is further coupled to memory 950, storage unit 960 and I/O interface unit 940. In one embodiment, controller 930 may be configured to control data access, retrieval and updating of the stored data in storage unit 960. Moreover, controller 930 may further be configured to control the operation of I/O interface unit 940 which communicates with other terminals connected in the network over the internet connection 104. In one embodiment, I/O interface circuit 840 may include a communication port configured to connect to other terminals in the network via connections such as, but not limited to, a modem dial-up through an internet service provider (ISP), a DSL or cable modem-type connection, and a T1, ISDN or LAN type connection. Communication port integrated in I/O interface circuit 840 may include, among others, one of a USB port, a serial port, a parallel port, an IEEE 1394 communication port, a IrDA communication port, and a Bluetooth enabled communication port.

Referring again to FIG. 9, storage unit 960 of server terminal 105 may include internal or external storage devices such as a hard disc drive (HDD), a CD-RW drive, or a zip drive. In one embodiment, storage unit 960 may be configured to store a variety of data received by server terminal 105 and processed by server terminal 105. In particular, storage unit 960 may include user account database 961, playlist database 962, and user playlist database 963. User account database 960 as discussed in further detail below may be configured to store information related to the registered users of the emarker system such as, for example, user name, address, account name, account password, and account status. Playlist database 962 may be configured to store playlists for each registered radio station broadcasts periodically received from playlist provider 106. Additionally, user playlist database 963 may be configured to store music clip broadcast playlists corresponding to the user's bookmarks.

As further shown in FIG. 9, controller 930 is coupled to memory 950 for accessing software and drivers for performing the various functions and processes of server terminal 105 for the e-marker fund music system. Indeed, in one embodiment, the e-marker information exchange system may be embodied as a computer program developed using an object oriented language that allows the modeling of complex systems with modular objects to create abstractions that are representative of real world, physical objects and their interrelationships. However, it would be understood by one of ordinary skill in the art that the various embodiments as described herein may be implemented in many different ways using a wide range of programming techniques as well as general purpose hardware systems or dedicated controllers.

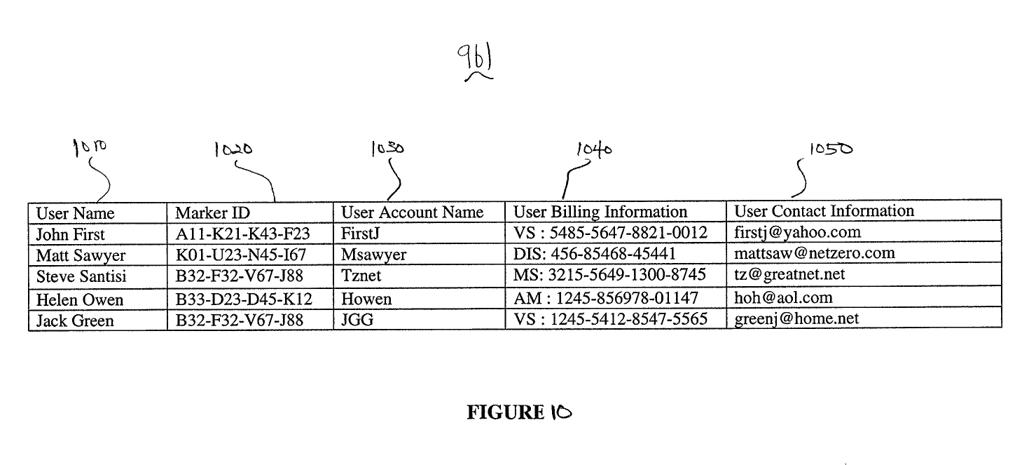

FIG. 10 illustrates a user account database of server terminal 105 storage unit 960 shown in FIG. 9. Referring to FIG. 10, user account database 1060 may include a user name field 1010, a marker identification (ID) field 1020, a user account name field 1030, a user billing information field 1040, and a user contact information field 1050. As can be seen from the figure, user name field 1010 may be configured to store the name of the user of music marker device 101, while marker ID field 1020 may be configured to store the music marker device ID corresponding to the respective device user name. For example, marker ID field 920 corresponding to the user John First may be configured to store the value “A11-K21-K43-F23” which corresponds to the marker device ID of John First. Moreover, marker ID field 1020 corresponding to the user Matt Sawyer may be configured to store the value “K01-U23-N45-I67” as the marker ID for Matt Sawyer. In this manner, for each user and their respective electronic music marker devices, a unique marker ID may be stored in user account database 961.

Referring back to FIG. 10, user account name field 1030 may be configured to store each user's account name, typically provided by the user, or alternatively, automatically assigned by the server terminal 105 (FIG. 1) upon user registration at the e-marker web site. For example, user account name field 1030 corresponding to the user John First may include “FirstJ” indicating John First's account name. While the user account names stored in the user account name field 1030 are shown as a combination of each user's initials and/or names, in one aspect, the user account name may be a combination of letters and number, a unique series of number, or any other data string which may uniquely identify the respective user.

As can be further seen from FIG. 10, user billing information field 1040 may be configured to store billing information such as credit card number, expiration date, and the type of credit card for each user. For example, user billing information field 1040 corresponding to the user Helen Owen may be configured to store the value “AM” indicating her American Express card, having a card number “1245-856978-01147”. In another aspect, user billing information field 1040 may include the user's bank account information such as the user's bank account name, account number, and so on. Moreover, in other embodiments, the user billing information field 1040 may include information corresponding to the user's transferable assets that the user wishes use as the preferred payment method for charges incurred, such as, for example, the user's frequent flier miles, the user's bank debit card, and so on.

Referring again to FIG. 10, user contact information field 1050 may be configured to store contact information corresponding to each user. For example, in one aspect, user contact information field 1050 may be configured to store email addresses of each respective user. Alternatively, user contact information field 1050 may be configured to store a telephone number, a facsimile number, a pager number or any other type of contact information for the respective users. Moreover, user account database 961 may be further configured to store other relevant information corresponding to the users. In this manner, from the information stored in user account database 961, server terminal 105 may retrieve information related to the respective user's account as well as to update the information stored in user account database 1061 based on received playlists from playlist provider 106 and/or the users themselves who are updating their corresponding account.

FIG. 11 illustrates one embodiment of a playlist database of the server terminal data storage unit shown in FIG. 9. Referring to FIG. 11, playlist database 962 includes broadcast time field 1110, name of music clip field 1120, name of artist field 1130, and name of album field 1140 for storing broadcast information corresponding to music broadcasts from registered radio station having call number KROK. As can be seen, broadcast time field 1110 is configured to store the beginning of the broadcast time for the corresponding music clip as well as the date of broadcast, and each of name of music clip field 1120, name of artist field 1130, and name of album field 1140 is configured to store the corresponding name of the music, the name of the artist and the name of the album for the broadcast music clip.

Indeed, in one embodiment, for each registered radio station, playlist provider 106 may be configured to transmit information related to the broadcasted music to server terminal 105 within a predetermined time from the actual broadcast time. Server terminal 105 is then configured to store the received playlist information for each registered radio stations in storage unit 960. Server terminal 105 may also be configured to update playlist database 962 periodically or at each predetermined interval based on playlist information received from playlist provider 106 such that the data stored in playlist database 962 is maintained as up to date as possible. Furthermore, while only one playlist database 962 is shown in FIG. 9, in accordance with the present invention, server terminal 105 may be configured to generate, store and update a playlist database similar to that shown in FIG. 11 for each radio broadcast station. Moreover, within the scope of the present invention, additional data fields may be incorporated in playlist database 962. Such additional data may include, for example, the number of music clip broadcast over a predetermined time period such as the number of same song broadcast within one day, the frequency information corresponding to the radio station broadcasting the music clips, and the Billboard chart ranking for each broadcast music album.

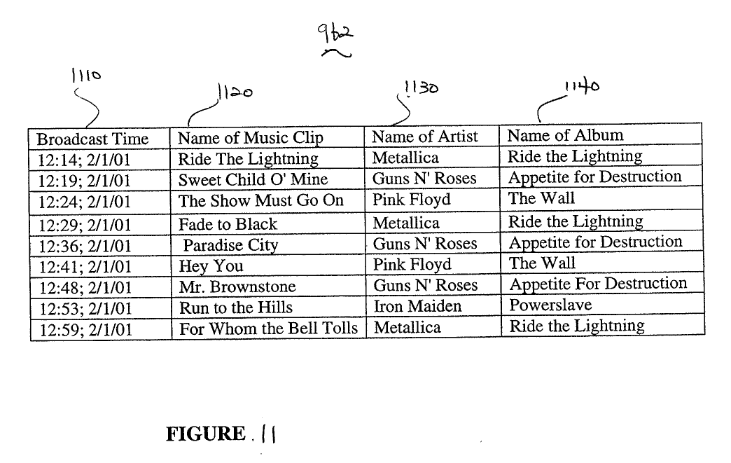

FIG. 12 illustrates one embodiment of a user playlist database of the server terminal data storage unit shown in FIG. 9. Referring to FIG. 12, playlist database 963 stored in server terminal 105 for user John First having user account name “FirstJ” includes music title field 1210, name of artist field 1220 corresponding to the name of the music title stored in music title field 1210, bookmark event field 1230, corresponding broadcast station field 1240, and genre field 1250.

As can be seen from the Figure, for each bookmark entered by John First using his electronic music marker device, once connected and synchronized with server terminal 105 via user terminal 103, information corresponding to the bookmarks are stored in the respective fields of user playlist database 963. For example, it can be seen from FIG. 12 that John First bookmarked the broadcast of the song titled “Ride the Lightning” by Metallica at 12:14 PM on Feb. 1, 2001, and that the song was broadcast from a radio station having call number KROK, the song classified in the hard rock category. In this manner, for each user of music marker device, server terminal 105 is configured to generate and store in user playlist database 962 information corresponding to the music broadcasts received from playlist provider 106 and the bookmarking information from each user's music marker device 101 via user terminal 103. Additionally, server terminal 105 may be configured to add additional data fields to user playlist database 963 as well as to modify and update user playlist database 963.

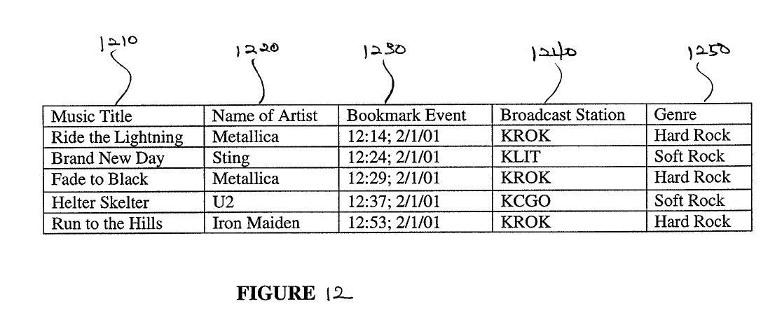

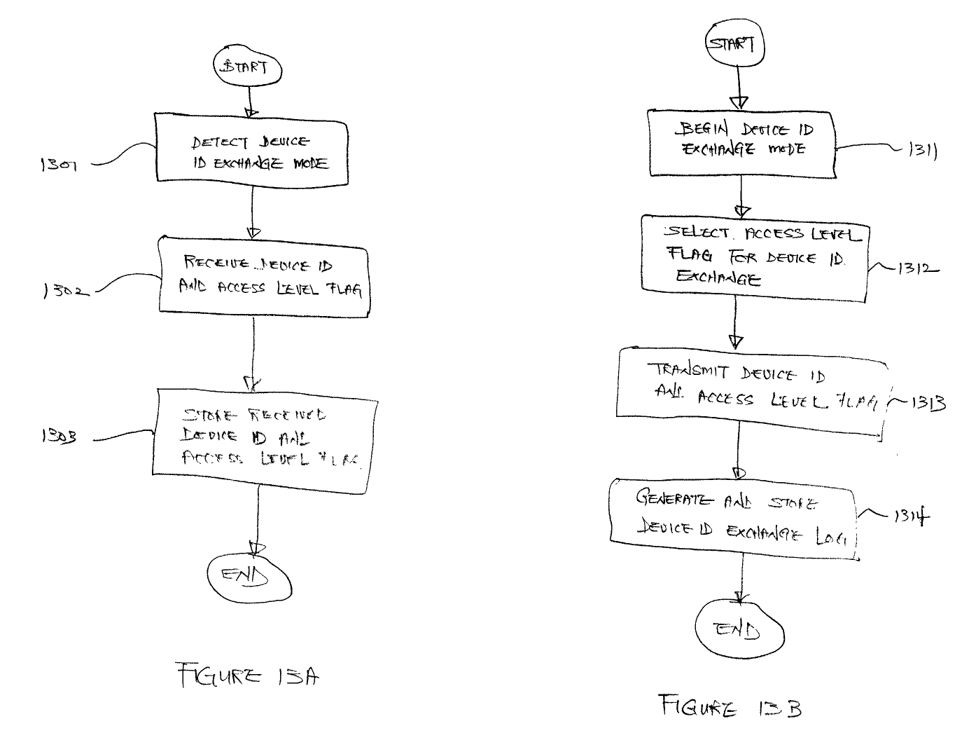

FIGS. 13A-13B are flowcharts for illustrating one embodiment of electronic music marker device ID exchange procedure. Referring to FIG. 13A, in one embodiment, at step 1301, a music marker device, for example, music marker device 101A detects device ID exchange mode transmitted from another music marker device, for example, music marker device 101B. At step 1302, device 101A receives device ID and a corresponding access level flag (for example, “restricted” to “unrestricted”) from device 101B. Thereafter, device 101A stores the received device ID and access level flag in the corresponding received ID field 520 and access level field 530 of ID exchange database 500 in memory 201.

Optionally, upon receiving the device ID and the corresponding access level flag from device 101B, device 101A may prompt its user to select whether the user wishes to transmit its own device ID and a desired access level flag to device 101B. In the case that the user of device 101A decides to transmit its own device ID, device 101A may be configured to transmit its device ID and the user selected access level flag to device 101B. In this manner, similar to bookmarking music clips broadcast over a radio or a television station, music marker devices 101 may be configured to directly exchange their respective unique device IDs and with an appropriate access level flag. As discussed previously, devices 101A-101C may directly communicate with each other to transmit and receive data to and from one another via I/O interface 205 through a communication port such as, for example, a Bluetooth enabled communication port, an IrDA port, and so on.

Referring to FIG. 13B, a user initiation of device ID exchange procedure is shown. In particular, at step 1311, the user of a music marker device, for example, device 101B decides to share (or transmit) the device ID with a desired access level to another device, for example, device 101C so that the user of device 101C may access the bookmarked music clips of device 101B. In one aspect, the user of device 101B may initiate the device ID exchange mode by operating one of input units 203A-203B by, for example, hard pressing one of input units 203A-203B for a predetermined time period such as three seconds, for example.

Then, the user is prompted to select a desired access level to be attached to the transmission of its device ID to device 101C. In particular, in one embodiment, a prompt signal may be displayed on display unit 207 of device 101A for the user to choose between a “restricted” flag and an “unrestricted” flag. Once the user selects the desired access level for the particular device ID transmission to device 101C at step 1312, then at step 1313, the device ID stored in device ID database 202 in memory 201 of device 101A is retrieved, and with the selected access level flag, transmitted to device 101C via I/O interface unit 205 of device 101B. Optionally, device 101B may be configured to generate and store a log of all transmission of its device IDs and the selected access level flags in memory 201 at step 1314.

In this manner, users of music marker devices may exchange their device IDs with a corresponding access level flags selected by the users such that other music marker devices may access the playlists of music clips bookmarked by the device users. Accordingly, in one embodiment, music marker device users may conveniently exchange bookmarked music clip playlists with friends, colleagues and acquaintances, and any other users of music marker devices and access that information through their respective emarker.com accounts without the need to recall the bookmarked music clip information.

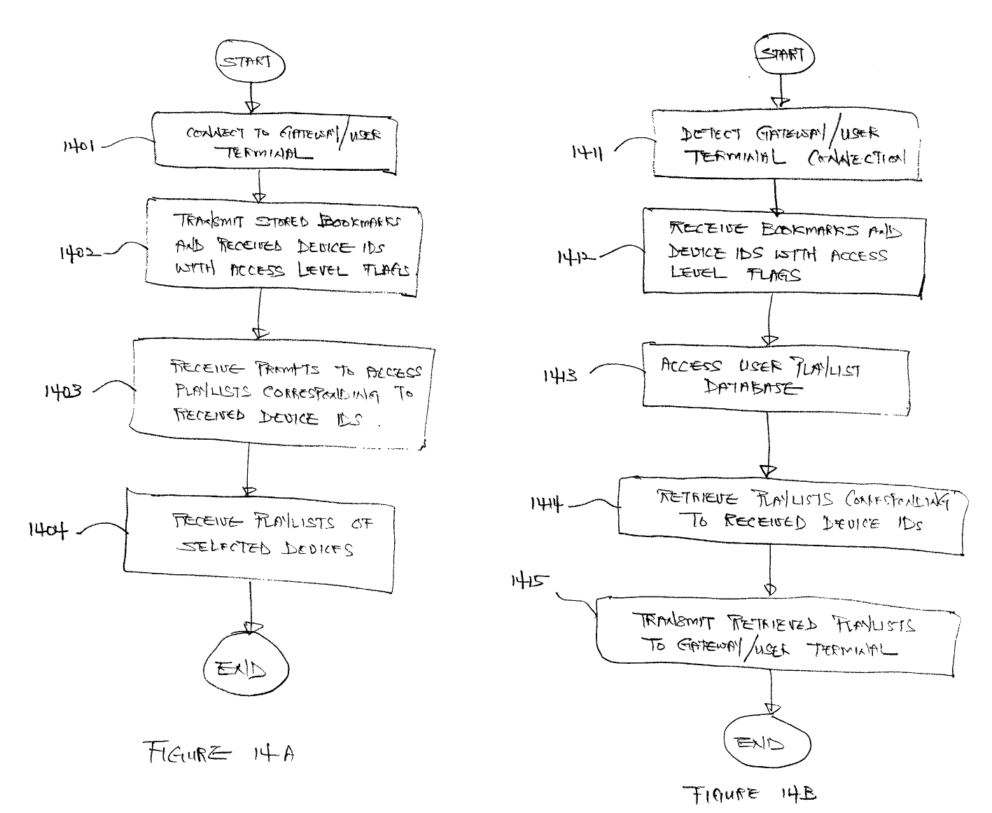

FIGS. 14A-14B are flowcharts for illustrating one embodiment of retrieving and transmitting playlist of other music marker devices after ID exchange procedure. Referring to FIG. 14A, at step 1401, marker device is coupled to user terminal for connection to e-marker.com server terminal. At step 1402, user terminal 103 is configured to transmit stored bookmarks of music clips and device IDs with access level flags received from other devices to server terminal 105 via data network 104. Thereafter, the user receives at user terminal 103 prompts to access playlists corresponding to the transmitted device IDs from server terminal 105 in addition to the information corresponding to its bookmarked music clips. Upon selection of the desired device ID(s), at step 1404, information corresponding to bookmarked music clips such as playlists of selected devices is received at user terminal 103 from server terminal 105.

In one embodiment, the information corresponding to bookmarked music clips such as playlists of selected devices received from server terminal 105 is similar to the information received from server terminal 105 corresponding to its own bookmarked music clips. For example, in one embodiment, for received device ID with access level flag “unrestricted”, the user of marker device that received this device ID may receive from server terminal all information related to the bookmarked music clips corresponding to the device with the received device ID such as the bookmarked music title information, time and date information corresponding to each bookmarked music. On the other hand, in the case where the access level flag for the received device ID is “restricted”, then the user of marker device who received this device ID may only be provided with limited information such as only the bookmarked music title information.

Referring to FIG. 14B, server terminal processing for device ID exchange is shown. In particular, at step 1411, server terminal 105 detects a connection or a plurality of connections from user terminal(s) 103. Then at step 1412, bookmarks and device IDs with corresponding access level flags are received from the connected user terminal(s) 103. Upon receiving the bookmarks and the device ID(s), server terminal 105 is configured to access user playlist database 963 of storage unit 960 corresponding to the received device ID(s) to retrieve information stored therein related to the bookmarked music clips from, for example, playlists stored in user playlist database 963 corresponding to the users of the received device ID(s). Thereafter at step 1414, server terminal retrieves playlists and information related to the playlists from the accessed user playlist database 963 based on the access level flag corresponding to the received device ID(s). The retrieved information and playlists are then transmitted to user terminal(s) 103 that transmitted the device ID(s) for output display on display unit 207 of user terminal(s) 103.

Server terminal 105 may further be configured to store and/or in user account database 961 corresponding to marker device user who, via user terminal 103 transmitted the bookmarks and received device IDs with access level flags, a record of requesting and receiving bookmarked music clip playlists of other marker device users. Additionally, server terminal 105 may also be configured to transmit a notification message or signal to user terminal 103 of marker device user whose user playlist database has been accessed by server terminal 105 for transmission of information stored therein to another marker device user terminal.

In the manner described above, in accordance with the various aspects of the present invention, users of music marker devices may easily and conveniently share information corresponding to their respective bookmarked music clips with each other, while retaining, if desired, a certain degree of security by imposing access level flags, for example with each exchange of device IDs with each other.

Various other modifications and alterations in the structure and method of operation of this invention will be apparent to those skilled in the art without departing from the scope and spirit of the invention. Although the invention has been described in connection with specific preferred embodiments, it should be understood that the invention as claimed should not be unduly limited to such specific embodiments. It is intended that the following claims define the scope of the present invention and that structures and methods within the scope of these claims and their equivalents be covered thereby.

What is claimed is:

1. A system for exchanging information between data marker devices, comprising:
a first data marker having a first marker identification; and
a second data marker configured to transmit a request for a marker identification to said first data marker, and in response thereto, receiving said first marker identification.

2. The system of claim 1 wherein said second data marker includes a second marker identification, wherein said first and second marker identifications are different.

3. The system of claim 1 wherein said first data marker includes a memory for storing said first marker identification, said first data marker configured to retrieve said first marker identification upon receiving said request for said marker identification.

4. The system of claim 3 wherein said first data marker is further configured to transmit said first marker identification to said second data marker.

5. The system of claim 3 wherein said first data marker is further configured to transmit an access level flag corresponding to said retrieved first marker identification.

6. The system of claim 5 wherein said access level flag includes one of an unrestricted flag and a restricted flag.

7. The system of claim 5 wherein said second data marker is further configured to receive said access level flag from said first data marker.

8. The system of claim 5 wherein said second data marker includes a memory for storing said received first data marker identification and said access level flag.

9. The system of claim 1 wherein said second data marker includes a second marker identification, said second data marker further configured to transmit said second marker identification to said first data marker.

10. The system of claim 9 wherein said first data marker includes a memory for storing said first marker identification and said second marker identification.

11. The system of claim 10 wherein said first marker identification is different from said second marker identification.

12. The system of claim 1 wherein said first data marker includes a first communication unit for receiving said request from said second data marker and transmitting said first marker identification, and wherein said second data marker includes a second communication unit for transmitting said request and receiving said first marker identification from said first data marker.

13. The system of claim 1 wherein each of said first and second communication units includes one of a Bluetooth enabled communication port, an IrDA communication port, a wireless-LAN enabled port, and a RF communication port.

13. The system of claim 1 further including:
a first user terminal configured to communicate with said second data marker; and
a server terminal configured to communicate with said first user terminal via a data network;
wherein said first user terminal is configured to transmit said received first marker identification to said server terminal; and further
wherein said server terminal is configured to transmit information corresponding to one or more data marks of said first data marker to said first user terminal.

14. The system of claim 13 wherein said first user terminal includes one of a personal computer terminal, a laptop computer terminal, a personal digital assistant, a WAP-enabled mobile telephone, and an i-mode mobile telephone.

15. The system of claim 13 wherein said first user terminal communicates with said second data marker via a cradle connection coupled to said second data marker and said first user terminal.

16. The system of claim 13 wherein said server terminal includes a storage unit for storing said information corresponding to more or more data marks of said first data marker.

17. The system of claim 16 wherein said server terminal is further configured to access said storage unit in response to receiving said first marker identification from said first user terminal.

18. The system of claim 17 wherein said server terminal is further configured to retrieve said information corresponding to said one or more data marks from said storage unit.

19. The system of claim 18 wherein said server terminal is further configured to update data storage unit.

20. The system of claim 13 wherein said data network includes one of an internet connection, a local area network, and a wide area network.

21. The system of claim 13 further including a playlist provider coupled to said server terminal, said playlist provider configured to transmit one or more playlist information corresponding to music clips broadcast over one or more of a radio and a television station.

22. The system of claim 21 wherein said playlist provider is configured to transmit said one or more playlist information at one of a predetermined time interval and in response to an update query received from said server terminal.

23. The system of claim 22 wherein said predetermined time interval includes one of a five minute interval or a ten minute interval from the termination of a broadcast of a corresponding music clip, and a 12 hour period.

24. A method, comprising:
receiving a device identification information;
transmitting said received device identification information; and
receiving information corresponding to a device having said device identification.

25. The method of claim 24 wherein said receiving step includes receiving an access level flag corresponding to said device identification information.

26. The method of claim 25 wherein said access level flag includes one of a restricted access flag and an unrestricted access flag.

27. The method of claim 24 wherein said device identification information includes one of a predetermined unique device identification code.

27. The method of claim 24 further including connecting to a gateway device for transmitting said received device identification information.

28. The method of claim 27 wherein said gateway device includes a user terminal comprising one of a personal computer, a laptop computer, a personal digital assistant, a WAP-enabled mobile telephone, and an i-mode mobile telephone.

29. The method of claim 24 wherein said received information corresponding to said device with said device identification includes information corresponding to data marked by said device.

30. The method of claim 29 wherein said information corresponding to said data marked by said device includes one or more of a broadcast music clip title information, artist information, album information, and time and date information corresponding to said data mark.

31. The method of claim 24 further including storing said device identification information.

32. The method of claim 24 further including displaying said information corresponding to said device having said device identification.

33. A method, comprising:
detecting a communication from a user terminal;
receiving a device identification information;
retrieving a playlist information corresponding to said device identification information; and
transmitting said playlist to said user terminal.

34. The method of claim 33 wherein said detecting step includes connecting to said user terminal.

35. The method of claim 34 wherein said connecting step includes establishing one of a TCP/IP protocol and an Appletalk protocol.

36. The method of claim 33 further including receiving an access level flag corresponding to said device identification information.

37. The method of claim 36 wherein said access level flag includes one of a restricted access flag and an unrestricted access flag.

38. The method of claim 33 wherein said retrieving step includes selecting a user playlist database corresponding to said device identification information.

39. The method of claim 38 wherein said playlist includes information corresponding to one or more broadcast music clips stored in said user playlist database.

40. The method of claim 39 wherein said information corresponding to each of said one or more broadcast music clips includes one or more of a title of the music clip, a name of the artist of the music clip, a name of the album of the music clip, and a purchase information corresponding to executing a purchase transaction of said music clip.

41. A method, comprising:
detecting a transmission of a third party device identification information;
receiving said third party device identification and an access level flag; and
storing said received third party device identification and said access level flag.

42. The method of claim 41 wherein said detecting step includes detecting a device identification exchange mode.

43. The method of claim 41 wherein said access level flag includes one of a restricted access flag and an unrestricted access flag.

44. The method of claim 41 further including transmitting a stored device identification information.

45. The method of claim 44 wherein said stored device identification information and said stored third party device identification are different.

46. The method of claim 41 further including:
designating an access level flag for a stored device identification information; and
transmitting said stored device identification information with said designated access level flag.

47. The method of claim 41 wherein said designated access level flag includes one of a restricted access flag and an unrestricted access flag.

48. A system for exchanging information between data marker devices, comprising:
first marking means having a first identification; and
second marking for transmitting a request for an identification to said first marking means, and in response thereto, receiving said first identification.
